(19) United States
(12) Patent Application Publication
(10) Pub. No.: US 2008/0070204 A1
(43) Pub. Date: Mar. 20, 2008

(54) Readers mate for comfortable and concentrative reading

(76) Inventor: Steve Sanghoo Kim, Des Plains, IL (US)

Correspondence Address: Steve S. Kim, Apt 201, 1480 Jefferson St, Des Plaines, IL, 60016, US

(21) Appl. No.: 11/497,772

(22) Filed: Aug. 15, 2006

(51) Int. Cl. G09B 17/00

(52) U.S. Cl. 434/178

(57) ABSTRACT

Readers should pay attention to the reading line among about seven lines of words around the reading line in the page. Furthermore, whenever reading line change, readers' eyes may be tired to find next line. To avoid these problems I invented a device for concentrative and comfortable reading. It is a flat and thin device which having a snug window of two to four lines space, and all other spaces of the device colored with cool and comfortable ones like blue, green or black for concentrative and comfortable reading through the window. By placing the bottom line of the window to the right below of the reading line, readers can concentrate to the reading line only without bothering by the other lines of words. There is a feel free also to find next lines by pulling down the device. I called this device is a READERS MATE.

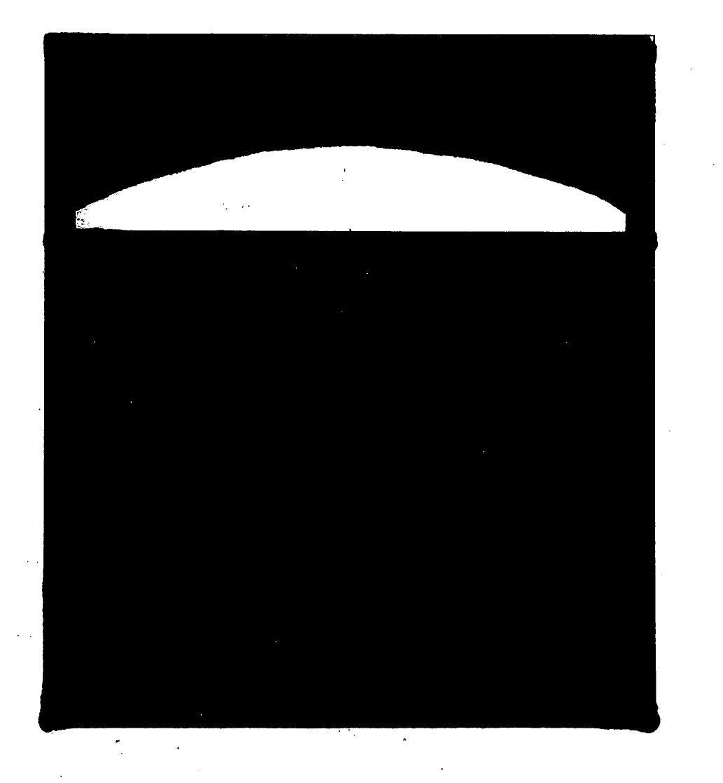

### CROSS-REFERENCE TO RELATED APPLICATION

Not Application

### STATEMENT REGARDING FEDERELY SPONSORED RESERCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND OF THE INVENTION

When I read a book, about seven lines of many words around the reading line appear together to my eyes. So, I have to pay attention to the reading line among the many words of lines above and down. That means less concentrative, uncomfortable situation and my eyes are tiring. Furthermore, whenever reading line change, my eyes tired to find next line. I thought that if I have a focusing device to the reading line through a window, it would be a very comfortable and efficiency reading. So, I figured out a device what I named READERS MATE to improve reading through the small window.

### BRIEF SUMMARY OF THE INVENTION

This READERS MATE is for reading improvement device which letting readers can concentrate with comfortable eyes on the each reading line among many words in the page. The READERS MATE is a thin and flat device colored with green, blue or black so on which is comfortable color(s) to eyes except window. The window of the device is the only open space to see the page, and the size of the window properly narrow to concentrate on the reading line. If readers place the bottom line of the window to the right below of the reading line, then the readers can concentrate only the focused line, and their eyes feel free from other words in the page. Especially, whenever reading line change readers' eyes free tiring of their eyes to find next line by pulling down the device.

### BRIEF DESCRIPTION OF THE SEVERAL VIEWS OF THE DRAWING

Readers mate: A thin and flat transparent plastic, paper or any material which having a window. All areas except window colored with dark blue, sky blue or black which are comfortable and cool for the eyes. The page can be seen only through the window. The reading line is focused by placing the bottom line of the window.

### DETAILED DESCRIPTION OF THE INVENTION

This READERS MATE is a thin and flat device which having a narrow window to see and focus to the reading line in the page by placing the bottom line of the window to the reading line for concentrative and comfortable reading. One of the good materials of the READERS MATE could be a transparent plastic. The sizes are variable according to books or any other reading materials. All of the devices should be colored with dull and comfortable color such as blue, green or black except the window. If the window had a natural sun light color with transparent, it would be the best. The size of the window can be affordable from two to five lines space. So, the window is surrounded by cool and a comfortable color or colors. Readers can concentrate to the reading line without eyes tiring through the window by placing the bottom line of the window to the reading line. Also, whenever line changing, it is free of eyes tiring by pulling down the window simply. This READERS MATES can be used also on the screen of the computer monitor.

I claim:

1. A thin and flat device which having a window surrounded by the comfortable color(s) for concentrative and comfortable reading by placing the bottom line of the window to the right below of the reading line.
